(19) United States
(12) Patent Application Publication
(10) Pub. No.: US 2019/0257985 A1
(43) Pub. Date: Aug. 22, 2019

(54) VARIABLE FOCUS LENS WITH INTEGRAL OPTICAL FILTER AND IMAGE CAPTURE DEVICE COMPRISING THE SAME

(71) Applicant: CORNING INCORPORATED, CORNING, NY (US)

(72) Inventors: Madapusi Kande Badrinarayan, Corning, NY (US); Joseph Marshall Kunick, Victor, NY (US); Paul Michael Then, Victor, NY (US)

(21) Appl. No.: 16/342,307

(22) PCT Filed: Oct. 18, 2017
(86) PCT No.: PCT/US17/57129

§ 371 Date: Apr. 16, 2019

Related U.S. Application Data
(60) Provisional application No. 62/409,850, filed on Oct. 18, 2016.
(60) Provisional application No. 62/415,069, filed on Oct. 31, 2016.

(51) Int. Cl. G02B 3/14; H04N 5/225; G02B 5/20; G06F 1/16

(52) U.S. Cl. CPC G02B 3/14; G06F 1/1686; G02B 5/20; H04N 5/2254

(57) ABSTRACT

A liquid lens includes a lens body having a first window, a second window, and a cavity disposed between the first window and the second window. A first liquid and a second liquid are disposed within the cavity of the lens body. The first liquid and the second liquid are substantially immiscible with each other and have different refractive indices such that an interface between the first liquid and the second liquid forms a lens. An optical filter is integrated with at least one of the first window or the second window. An image capture device includes an optical system having a variable focus lens, an image sensor, and an optical filter integrated with the optical system. Each of the image sensor and the optical filter is aligned along an optical axis of the optical system.

This application claims the benefit of priority to U.S. Provisional Application No. 62/409,850, filed Oct. 18, 2016, and U.S. Provisional Application No. 62/415,069, filed Oct. 31, 2016, the content of each of which is incorporated herein by reference in its entirety.

### BACKGROUND

### 1. Field

This disclosure relates to lenses, and more particularly, to variable focus lenses with integral optical filters.

### 2. Technical Background

Liquid lenses or fluid lenses are a type of variable focus lenses that generally include a cavity with a polar or conducting liquid and a non-polar or insulating liquid disposed therein. The liquids are immiscible with each other and have different refractive indices such that the interface between the liquids forms a lens. The shape of the interface can be changed via electrowetting. For example, a voltage can be applied between the polar liquid and a surface of the cavity to increase or decrease the wettability of the surface with respect to the polar liquid and change the shape of the interface. Changing the shape of the interface changes the focal length or focus of the lens.

Digital camera image sensors, such as complementary metal-oxide-semiconductor (CMOS) detectors, are sensitive to electromagnetic radiation over a fairly large wavelength region. Due to size and cost limitations, optical systems in cameras typically are not designed to correct for the full spectral region covered by the image sensor. Therefore, the portion of the electromagnetic spectrum beyond the corrected band should be filtered or removed to avoid negatively impacting the image quality of the camera. A plate filter having a substrate with a dielectric coating can be added to the camera lens system. The dielectric coating is designed to transmit light in the visible region where the optical system is corrected and block light in the infrared region and/or the ultraviolet region where the optical system is not corrected. The plate filter can be attached directly to the image sensor such that it also serves a secondary function as a dust cover that prevents particles generated or displaced from other parts of the camera from falling on the image sensor surface (e.g., when the lens stack is moved for autofocus or optical image stabilization purposes).

### SUMMARY

Disclosed herein are image capture devices comprising optical systems with variable focus lenses.

Disclosed herein is a liquid lens comprising a lens body comprising a first window, a second window, and a cavity disposed between the first window and the second window. A first liquid and a second liquid are disposed within the cavity of the lens body. The first liquid and the second liquid are substantially immiscible with each other and have different refractive indices such that an interface between the first liquid and the second liquid forms a lens. An optical filter is integrated with at least one of the first window or the second window.

Disclosed herein is an image capture device comprising an optical system, an image sensor, and an optical filter integrated with the optical system. The optical system comprises a variable focus lens. Each of the image sensor and the optical filter is aligned along an optical axis of the optical system.

Disclosed herein is a liquid lens comprising a lens body comprising a first window, a second window, and a cavity disposed between the first window and the second window. A first liquid and a second liquid are disposed within the cavity of the lens body. The first liquid and the second liquid are substantially immiscible with each other and have different refractive indices such that an interface between the first liquid and the second liquid forms a lens. A first optical filter segment is disposed on an outer surface of the first window and comprises a dielectric stack. A second optical filter segment is disposed on an outer surface of the second window and comprises an absorbing layer and a dielectric stack.

Disclosed herein is a method for forming a liquid lens, the method comprising forming at least a portion of an optical filter on a surface of one of a first outer layer or a second outer layer. The method further comprises bonding the first outer layer to an object side surface of an intermediate layer and bonding the second outer layer to an image side surface of the intermediate layer, thereby forming a cavity disposed between the first outer layer and the second outer layer.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic view of a conventional image capture device.

FIG. 2 is a schematic view of exemplary embodiments of an image capture device comprising a variable focus lens with an integrated optical filter.

FIG. 3 is a schematic cross-sectional view of exemplary embodiments of an image capture device.

FIG. 4 is a schematic cross-sectional view of exemplary embodiments of an image capture device.

FIG. 5 is a schematic cross-sectional view of exemplary embodiments of a variable focus lens with an integral optical filter.

FIG. 6 is a close-up view of exemplary embodiments of an optical filter segment of the integral optical filter shown in FIG. 5.

FIG. 7 is a close-up view of exemplary embodiments of an optical filter segment of the integral optical filter shown in FIG. 5.

FIG. 8 is a graph of an exemplary transmission profile of an optical filter.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

In various embodiments, a liquid lens comprises a lens body comprising a first window, a second window, and a cavity disposed between the first window and the second window. A first liquid and a second liquid are disposed within the cavity of the lens body. The first liquid and the second liquid are substantially immiscible with each other and have different refractive indices such that an interface between the first liquid and the second liquid forms a lens. An optical filter is integrated with at least one of the first window or the second window. For example, the optical filter is disposed on an outer surface of at least one of the first window or the second window. In some embodiments, at least one of the first window or the second window itself serves as at least a portion of the optical filter (e.g., an absorbing layer). Integrating the optical filter into the liquid lens can enable an image capture device comprising the liquid lens to have a reduced thickness compared to a conventional image capture device comprising a separate optical filter plate that is not integrated into the optical system. Additionally, or alternatively, flat outer surfaces of the liquid lens can enable deposition of the optical filter thereon using deposition techniques that may not be suitable for depositing the optical filter on a curved surface of a fixed lens.

In various embodiments, an image capture device comprises an optical system, an image sensor, and an optical filter integrated with the optical system. The optical system comprises a variable focus lens. Each of the image sensor and the optical filter is aligned along an optical axis of the optical system. The variable focus lens can enable the optical system to perform an optical focus, an autofocus, and/or an optical image stabilization function without movement of the optical system relative to the image sensor. Thus, the optical system can be bonded directly to the image sensor and/or the optical system and the image sensor can be disposed within a sealed chamber, which can obviate the need for a separate dust cover bonded to the image sensor and enable integration of the optical filter into the optical system.

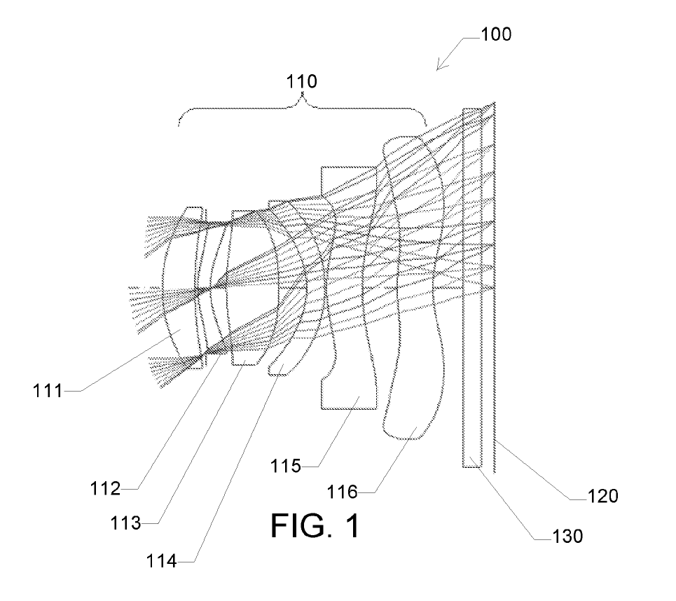

FIG. 1 is a schematic view of a conventional image capture device 100. Image capture device 100 comprises an optical system 110 positioned to focus image light on an image sensor 120. Optical system 110 comprises a plurality of lenses. For example, optical system 110 comprises, in order from an object side to an image side, a first lens 111, a second lens 112, a third lens 113, a fourth lens 114, a fifth lens 115, and a sixth lens 116. Each lens of optical system 110 is a fixed lens. Thus, the focal length of each lens of optical system 110 is fixed. Image capture device 100 comprises an optical filter 130 disposed between optical system 110 and image sensor 120. Optical filter 130 is a bandpass filter that transmits visible light and blocks infrared (IR) and ultraviolet (UV) light. Optical filter 130 can be bonded to the object side surface of image sensor 120. Optical system 110 can be spaced from optical filter 130 such that an air gap is disposed between the optical system and the optical filter (e.g., between sixth lens 116 and the optical filter). Optical system 110, or a portion thereof, can be moved relative to image sensor 120 in the object side direction (e.g., away from the image sensor) or the image side direction (e.g., toward the image sensor). Such movement of optical system 110 can change the focus of the optical system. Such movement of optical system 110 can be accomplished using a linear actuator such as a voice coil. Physical movement of optical system 110 can generate or release particles (e.g., dust) and/or enable particles to enter the air gap between the optical system and optical filter 130. Optical filter 130 bonded to image sensor 120 can serve as a dust cover to protect the image sensor from particles that may otherwise settle on the image sensor and degrade the image quality.

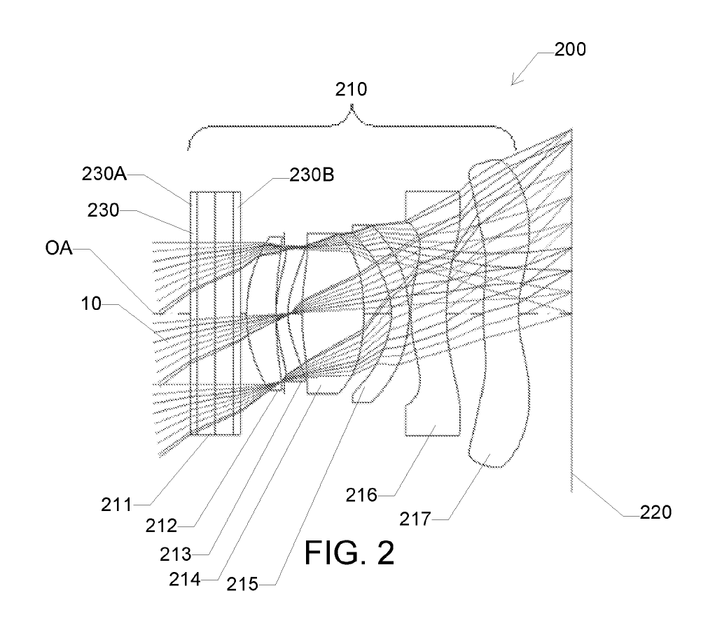

FIG. 2 is a schematic view of exemplary embodiments of an image capture device 200. Image capture device 200 comprises an optical system 210 and an image sensor 220. Optical system 210 can be positioned to focus image light 10 on image sensor 220 as shown in FIG. 2.

In some embodiments, optical system 210 comprises a plurality of lenses. For example, in the embodiments shown in FIG. 2, optical system 210 comprises, in order from an object side to an image side, a first lens 211, a second lens 212, a third lens 213, a fourth lens 214, a fifth lens 215, a sixth lens 216, and a seventh lens 217. The plurality of lenses can be aligned along an optical axis OA of optical system 210. In some embodiments, at least one lens of optical system 210 is a variable focus lens. For example, in the embodiments shown in FIG. 2, first lens 211 is a variable focus lens. In some embodiments, the variable focus lens is a liquid lens or a fluid lens as described herein. The focus of the liquid lens or fluid lens can be changed by changing the shape of the interface between the different liquids contained within the lens and without translating, tilting, or otherwise moving optical system 210 relative to image sensor 220. In other embodiments, the variable focus lens is a hydrostatic fluid lens comprising a fluid disposed within a flexible membrane. The focus of the hydrostatic fluid lens can be changed by changing the hydrostatic pressure of the fluid, and thus the curvature of the flexible membrane, and without translating, tilting, or otherwise moving the optical system relative to the image sensor. In other embodiments, the variable focus lens is another type of lens having a focal length that can be changed without translating, tilting, or otherwise moving the optical system relative to the image sensor.

In some embodiments, image capture device 200 is free of an air gap between optical system 210 and image sensor 220. For example, optical system 210 is bonded directly to image sensor 220 as described herein. Thus, optical system 210 is not movable relative to image sensor 220. The absence of an air gap and/or a direct bond between optical system 210 and image sensor 220 can be enabled by the variable focus lens of the optical system. For example, the focus of optical system 210 can be changed without physical movement of the optical system relative to image sensor 220 (e.g., by changing the focus of the variable focus lens). Thus, there is no need for an air gap between optical system 210 and image sensor 220 to allow for such physical movement.

In some embodiments, image capture device 200 comprises an optical filter 230. For example, optical filter 230 is a spectral filter that blocks or removes radiation to which image sensor 220 is sensitive, but not corrected by the optical train (e.g., optical system 210). In some embodiments, optical system 210 is corrected in the visible region (e.g., about 450 nm to about 650 nm), and optical filter 230 blocks or rejects radiation in the near-IR region (e.g., about 650 nm to about 1500 nm) and shorter UV region (<about 450 nm).

In some embodiments, optical filter 230 is integrated into optical system 210. For example, in the embodiments shown in FIG. 2, optical filter 230 is disposed on a surface of first lens 211 (e.g., the variable focus lens). Thus, optical filter 230 is integrated with first lens 211. In other embodiments, optical filter 230 is integrated with or disposed on a surface of another lens (e.g., a fixed lens) of optical system 210. In some embodiments, optical filter 230 comprises a plurality of optical filter segments. For example, in the embodiments shown in FIG. 2, optical filter 230 comprises a first optical filter segment 230A and a second optical filter segment 230B. Different optical filter segments can be disposed on different surfaces within optical system 210. For example, in the embodiments shown in FIG. 2, first optical filter segment 230A is disposed on the object side of first lens 211, and second optical filter segment 230B is disposed on the image side of the first lens. Dividing optical filter 230 into a plurality of optical filter segments can help to improve the performance of the optical filter. In some embodiments, optical filter 230 comprises a dielectric stack. For example, the dielectric stack comprises alternating layers of high and low refractive index materials with suitable thicknesses to reflect light in one or more particular wavelength ranges (e.g., IR and/or UV light). Additionally, or alternatively, optical filter 230 comprises an absorptive material that absorbs light in one or more particular wavelength ranges (e.g., near-IR light). Thus, optical filter 230 can serve as a bandpass filter that transmits visible light and reflects and/or absorbs one or more of IR, near-IR, and/or UV light.

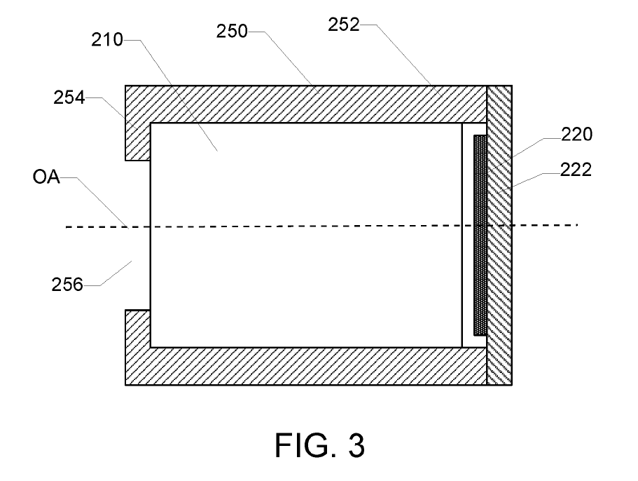

FIG. 3 is a schematic cross-sectional view of exemplary embodiments of image capture device 200. In the embodiments shown in FIG. 3, image capture device 200 comprises optical system 210 and image sensor 220, which can be configured as described herein in reference to FIG. 2. Although optical system 210 is shown schematically in FIG. 3 as a single block, the optical system can comprise a plurality of lenses as described herein, including the variable focus lens. In some embodiments, image capture device 200 comprises a housing 250. For example, housing 250 comprises a sidewall 252 surrounding an interior region in which optical system 210 can be disposed as described herein. In some embodiments, sidewall 252 is disposed about optical axis OA of optical system 210. For example, sidewall 252 is rotationally symmetric about optical axis OA. In some embodiments, sidewall 252 comprises a cylindrical shape with a circular or elliptical cross-section. In other embodiments, sidewall 252 comprises a square, triangular, rectangular, or other polygonal or non-polygonal cross-section. In some embodiments, housing 250 comprises an end cap 254. For example, end cap 254 is disposed at a distal end (e.g., the object end) of housing 250 and protrudes inward from sidewall 252 into the interior region of housing 250 toward optical axis OA. End cap 254 can help to secure optical system 210 inside housing 250 (e.g., by preventing the optical system or components thereof from exiting the object end of the housing). In some embodiments, end cap 254 defines an aperture 256 through which image light 10 can pass to be focused by optical system 210 onto image sensor 220 as described herein.

In some embodiments, optical system 210 is disposed within housing 250. For example, optical system 210 is disposed within the interior region of housing 250. In some embodiments, optical system 210 is coupled to housing 250. For example, sidewall 252 of housing 250 comprises interior threads engaged with exterior threads of optical system 210 such that the optical system is in threaded engagement with the housing. Additionally, or alternatively, sidewall 252 of housing comprises one or more interior pawls engaged with exterior notches of optical system 210 such that the optical system is in a snap-fit engagement with the housing. Such coupling of optical system 210 to housing 250 can help to fix the optical system in place and prevent undesired movement of the optical system relative to image sensor 220 as described herein.

In some embodiments, image sensor 220 is disposed within housing 250. For example, image sensor 220 is disposed within the interior region of housing 250. In some embodiments, image sensor 220 is coupled to housing 250. For example, image sensor 220 can be coupled to housing 250 as described herein with reference to optical system 210. In the embodiments shown in FIG. 3, image sensor 220 is disposed on a substrate 222. For example, substrate 222 comprises a printed circuit board (PCB). Substrate 222 can enable electrical connection to image sensor 220 (e.g., through electrical traces disposed on or in the substrate). Additionally, or alternatively, various electronic components that control operation of or process signals to or from image sensor 220 can be disposed on substrate 222. In some embodiments, housing 250 is coupled to substrate 222. For example, a proximal end (e.g., the image end) of sidewall 252 is coupled to substrate 222 such that image sensor 220 is disposed within housing 250 as shown in FIG. 3.

In some embodiments, optical system 210 is spaced from image sensor 220 such that an air gap is disposed between the optical system and the image sensor. For example, a proximal lens of optical system 210 (e.g., disposed at the image end of the optical system) is spaced from image sensor 220 such that the air gap is disposed between the proximal lens and the image sensor as shown in FIG. 3.

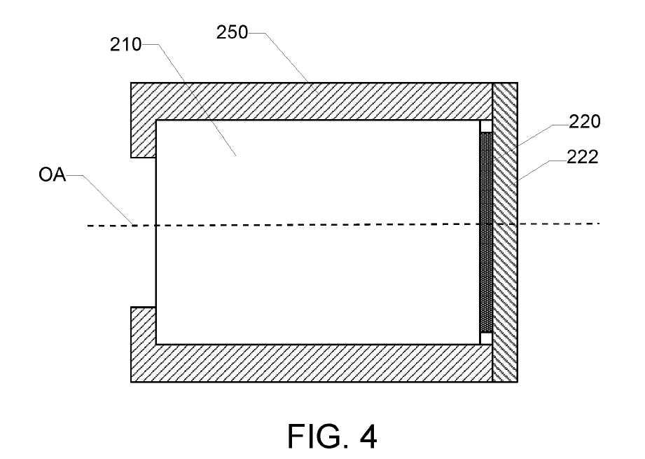

In other embodiments, optical system 210 is bonded directly to image sensor 220. FIG. 4 is a schematic cross-sectional view of exemplary embodiments of image capture device 200. The embodiments shown in FIG. 4 are the same as those shown in FIG. 3, except that optical system 210 shown in FIG. 4 is bonded directly to image sensor 220 such that no air gap is disposed between the optical system and the image sensor. For example, the proximal lens of optical system 210 is bonded directly to image sensor 220 (e.g., with an optically clear adhesive or other suitable adhesive) such that no air gap is disposed between the proximal lens and the image sensor.

In some embodiments, each of optical system 210 and image sensor 220 is directly or indirectly coupled to housing 250 such that a sealed chamber is defined within the housing (e.g., between first lens 211 of the optical system and the image sensor). For example, in the embodiments shown in FIGS. 3-4, a sealed chamber is defined within housing 250 between first lens 211 of optical system 210 and substrate 222. In some embodiments, image sensor 220 is disposed within the sealed chamber. In some of such embodiments, optical system 210 comprises a variable focus lens as described herein. Thus the focal length of optical system 210 can be adjusted (e.g., for focus and/or autofocus) and/or the interface between the liquids can be tilted (e.g., for optical image stabilization) without physically moving the optical system relative to image sensor 220. The positioning of image sensor 220 within the sealed chamber and the lack of movement of optical system 210 can reduce the potential for particles to be generated (e.g., by movement of a voice coil or other mechanical actuator) or allowed to enter the housing (e.g., by a gap created by mechanically tilting a fixed lens) and fall onto the image sensor. Thus, image sensor 220 disposed within the sealed chamber can be free of a dust cover (e.g., optical filter 130 shown in FIG. 1 or another cover) intended to prevent particles from falling on the surface of the image sensor and degrading the image quality.

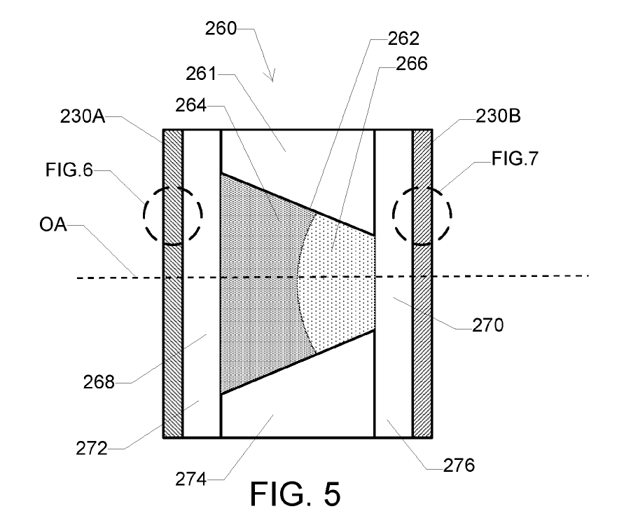

FIG. 5 is a schematic cross-sectional view of exemplary embodiments of a variable focus lens 260 with an integral optical filter 230. For example, variable focus lens 260 can serve as one lens (e.g., first lens 211) of optical system 210 described herein in reference to FIGS. 2-4. In some embodiments, variable focus lens 260 is a liquid lens or a fluid lens. For example, variable focus lens 260 comprises a lens body 261 and a cavity 262 formed in the lens body. A first liquid 264 and a second liquid 266 are disposed within cavity 262. In some embodiments, first liquid 264 is a polar liquid or a conducting liquid. Additionally, or alternatively, second liquid 266 is a non-polar liquid or an insulating liquid. In some embodiments, first liquid 264 and second liquid 266 are immiscible with each other and have different refractive indices such that the interface between the first liquid and the second liquid forms a lens. The shape of the interface can be changed via electrowetting. For example, a voltage can be applied between first liquid 264 and a surface of cavity 262 (e.g., an electrode positioned near the surface of the cavity and insulated from the first liquid) to increase or decrease the wettability of the surface of the cavity with respect to the first liquid and change the shape of the interface. In some embodiments, changing the shape of the interface changes the focal length or focus of variable focus lens 260. For example, such changing focal length can enable variable focus lens 260 to be used for manual focus or autofocus applications. Additionally, or alternatively, changing the shape of the interface tilts variable focus lens 260 relative to optical axis OA. For example, such tilting can enable variable focus lens 260 to maintain an image in position on image sensor 220 as optical system 210 shakes or vibrates (e.g., for optical image stabilization). Changing the shape of the interface can be achieved without physical movement of variable focus lens 260 relative to image sensor 220 as described herein. For example, lens body 261 can remain stationary relative to image sensor 220 as the shape of the interface changes. In some embodiments, first liquid 264 and second liquid 266 have substantially the same density, which can help to avoid changes in the shape of the interface as a result of changing the physical orientation of variable focus lens 260 (e.g., as a result of gravitational forces).

In some embodiments, lens body 261 of variable focus lens 260 comprises a first window 268 and a second window 270. In some of such embodiments, cavity 262 is disposed between the first window and the second window. In some embodiments, lens body 261 comprises a plurality of layers that cooperatively form the lens body. For example, in the embodiments shown in FIG. 5, lens body 261 comprises a first outer layer 272, an intermediate layer 274, and a second outer layer 276. In some of such embodiments, intermediate layer 274 comprises a bore formed therethrough, first outer layer 272 is bonded to one side (e.g., the object side) of the intermediate layer, and second outer layer 276 is bonded to the other side (e.g., the image side) of the intermediate layer such that the bore is covered on opposing sides by the first outer layer and the second outer layer, and cavity 262 is defined within the bore. Thus, a portion of first outer layer 272 covering cavity 262 serves as first window 268, and a portion of second outer layer 276 covering the cavity serves as second window 270. In some embodiments, cavity 262 is tapered as shown in FIG. 5 such that a cross-sectional area of the cavity decreases or increases along optical axis OA in a direction from the object side to the image side. Such a tapered cavity can help to maintain alignment of the interface between first liquid 264 and second liquid 266 along optical axis OA. In other embodiments, the cavity is non-tapered such that the cross-sectional area of the cavity remains substantially constant along optical axis OA. In some embodiments, image light 10 enters variable focus lens 260 through first window 286, is refracted at the interface between first liquid 264 and second liquid 266, and exits the variable focus lens through second window 270. In some embodiments, first outer layer 272 and/or second outer layer 276 comprise a sufficient transparency to enable passage of image light 10 as described herein. For example, first outer layer 272 and/or second outer layer 276 comprise a glass, ceramic, or glass-ceramic material. Additionally, or alternatively, outer surfaces of first outer layer 272 and/or second outer layer 276 are substantially planar. Thus, even though variable focus lens 260 can function as a lens (e.g., by refracting image light 10 passing therethrough), outer surfaces of the variable focus lens can be flat as opposed to being curved like the outer surfaces of a fixed lens. Such flat outer surfaces can enable the optical filter to be integrated with the variable focus lens as described herein. In some embodiments, intermediate layer 274 comprises a metallic, polymeric, glass, ceramic, or glass-ceramic material. Because image light 10 can pass through the bore through intermediate layer 274, the intermediate layer may or may not be transparent.

In some embodiments, optical filter 230 is integrated with variable focus lens 260. In some of such embodiments, optical filter 230 is disposed on an outer surface of variable focus lens 260. For example, in the embodiments shown in FIG. 5, first optical filter segment 230A is disposed on one outer surface (e.g., the object side surface) of variable focus lens 260, and second optical filter segment 230B is disposed on the other outer surface (e.g., the image side surface) of the variable focus lens. In some embodiments, optical filter 230 comprises a dielectric stack. For example, optical filter 230 comprises alternating layers of a high refractive index material and a low refractive index material. In some embodiments, the high refractive index material and/or the low refractive index material comprise metal oxide materials (e.g., TiO₂, Al₂O₃, SiO₂, or another metal oxide material). The thicknesses of the layers of the dielectric stack can be selected such that the dielectric stack reflects light in a determined wavelength range as described herein. Thus, the dielectric stack can function as an interference filter.

In some embodiments, optical filter 230 comprises an absorbing layer. For example, in some embodiments, the absorbing layer comprises a dye (e.g., a cyanine compound, a phthalocyanine compound, a naphthalocyanine compound, a dithiol metal complex compound, a diimonium compound, a polymethine compound, a phthalide compound, a naphthoquinone compound, an anthraquinone compound, an indophenol compound, a squarylium compound, or another absorbing compound) that absorbs light in a determined wavelength range as described herein. In some of such embodiments, the dye is dispersed in a resin (e.g., a transparent resin). In other embodiments, the absorbing layer comprises a tinted glass, ceramic, or glass-ceramic layer. For example, the absorbing layer comprises a blue filter glass.

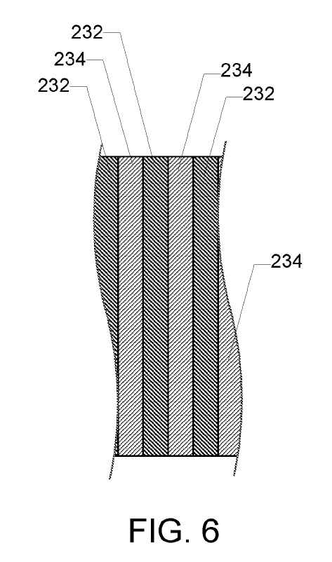

FIG. 6 is a close-up view of first optical filter segment 230A shown in FIG. 5. In some embodiments, optical filter segment 230A comprises a dielectric stack comprising alternating high refractive index layers 232 and low refractive index layers 234. The number of layers and the layer thicknesses can be selected such that optical filter segment 230A transmits a relatively small amount of UV light. Thus, optical filter segment 230A blocks UV light to enable optical filter 230 to exhibit the lower cutoff wavelength described herein.

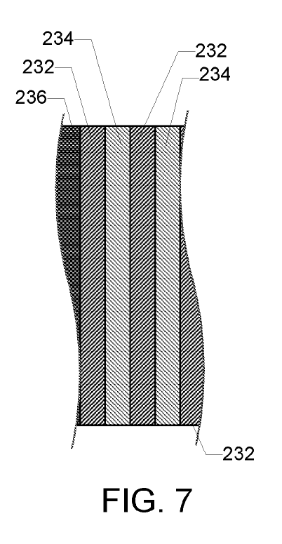

FIG. 7 is a close-up view of second optical filter segment 230B shown in FIG. 5. In some embodiments, optical filter segment 230B comprises an absorbing layer 236 comprising an absorbing dye dispersed in a transparent resin. The dye, the resin, and the layer thickness can be selected such that absorbing layer 236 transmits a relatively small amount of near-IR light. Thus, absorbing layer 236 blocks near-IR light to enable optical filter 230 to exhibit the upper cutoff wavelength described herein.

In some embodiments, optical filter segment 230B comprises a dielectric stack comprising alternating high refractive index layers 232 and low refractive index layers 234. The number of layers and the layer thicknesses can be selected such that optical filter segment 230B serves as an anti-reflection (AR) layer. The AR layer can help to reduce the amount of visible light that is reflected by variable focus lens 260, and thereby increase the amount of visible light transmitted toward image sensor 220. In some embodiments, the AR layer is positioned at the image surface of optical filter 230 (e.g., disposed on the AR layer). For example, absorbing layer 236 is disposed between variable focus lens 260 and the AR layer. Thus, UV light and/or near-IR light can be filtered from image light 19 (e.g., by first optical filter segment 230A and/or absorbing layer 236, respectively) before the image light reaches the AR layer. Such positioning can help to improve the efficiency of the AR layer.

As used herein, the terms “high refractive index” and “low refractive index” are relative terms. For example, a high refractive index layer or material has a higher refractive index than a low refractive index layer or material and vice versa. In the embodiments shown in FIGS. 5-7, the high refractive index layers or materials of first optical filter segment 230A can be the same as or different than the high refractive index layers or materials of second optical filter segment 230B, and the low refractive index layers or materials of the first optical filter segment can be the same as or different than the low refractive index layers or materials of the second optical filter segment.

Although optical filter 230 described herein in reference to FIGS. 5-7 comprises first optical filter segment 230A and second optical filter segment 230B, other embodiments are included in this disclosure. For example, in other embodiments, the optical filter comprises a single optical filter segment or multiple optical filter segments comprising a dielectric stack, an absorbing layer, or both. Additionally, or alternatively, the dielectric stack can comprise multiple segments. For example, a dielectric stack can comprise a blocking segment that blocks UV light and an AR segment that enhances transmission of visible light. In various embodiments, a dielectric stack (with or without multiple segments) and an absorbing layer can be disposed on the same or opposing outer surfaces of a variable focus lens. In various embodiments, a layer “disposed” on an outer surface of a variable focus lens can be disposed directly on the outer surface or on another layer disposed directly or indirectly on the outer surface.

Although absorbing layer 236 of optical filter 230 described herein in reference to FIGS. 5-7 is disposed on an outer surface of variable focus lens 260, other embodiments are included in this disclosure. For example, in other embodiments, the first window and/or the second window of the variable focus lens comprises the absorbing layer. Thus, the respective first window and/or second window is formed from an absorbing material that absorbs light in the upper wavelength range above the upper cutoff wavelength as described herein. For example, in some embodiments, first layer 274 and/or second layer 276 of variable focus lens 260 comprises or is formed from a blue filter glass or a polymeric material comprising an absorbing dye as described herein. Additionally, or alternatively, the optical filter comprises one or more dielectric stacks disposed on outer surfaces of the absorbing first window and/or second window.

Optical filter 230 integrated with optical system 210 as described herein can enable image capture device 200 to have a reduced thickness compared to a conventional image capture device with a separate optical filter plate (e.g., as shown in FIG. 1). For example, optical filter 230 integrated with optical system 210 can be thinner than a separate optical filter plate because the lens on which optical filter 230 is disposed (e.g., variable focus lens 260) can serve as the substrate for optical filter 230, obviating a requirement for a separate substrate included in the optical filter plate. Thus, image capture device 200 comprising optical system 210 with integrated optical filter 230 can be thinner than a conventional image capture device with a separate optical filter plate (e.g., by a thickness of the substrate of the separate optical filter plate). For example, image capture device 200 comprising optical system 210 with integrated optical filter 230 can be about 0.1 mm to about 3 mm thinner than a conventional image capture device with a separate optical filter plate.

Optical filter 230 integrated with optical system 210 as described herein can help to reduce the potential for breaking the optical filter compared to a conventional image capture device with a separate optical filter plate (e.g., as shown in FIG. 1). For example, movement of the optical system relative to the image sensor in the conventional image capture device can result in physical contact between the optical system and the optical filter disposed between the optical system and the image sensor, which can damage or break the optical filter. Optical filter 230 integrated with optical system 210 reduces the possibility for such contact and breakage. For example, even if optical system 210 moves relative to image sensor 220, optical filter 230 will move as well, thus preventing contact and/or breakage of the optical filter. Additionally, or alternatively, incorporating variable focus lens 260 into optical system 210 can avoid movement of the optical system relative to image sensor 220 as described herein, thus preventing contact and or breakage of optical filter 230.

In some embodiments, a dielectric stack is deposited on an outer surface of variable focus lens 260 using physical vapor deposition, chemical vapor deposition, atomic layer deposition, plasma deposition, ion assisted deposition, or another suitable deposition process. Additionally, or alternatively, an absorbing layer is deposited on an outer surface of variable focus lens 260 using spin coating, spray coating, dip coating, die coating, slot die coating, gravure printing, or another suitable coating or printing process. In various embodiments, the outer surface of variable focus lens 260 can be planar or non-planar. Variable focus lens 260 with planar outer surface can enable application of dielectric stacks and/or absorbing layers with precise layer thicknesses. Thus, variable focus lens 260 with planar outer surfaces can enable integration of optical filter 230 into optical system 210 using deposition, printing, and/or coating processes that may not be suitable for use on fixed lenses with non-planar outer surfaces.

In some embodiments, a dielectric stack can be deposited on an outer surface of variable focus lens 260 using a high-temperature deposition process. For example, such a high-temperature deposition process comprises depositing one or more layers of the dielectric stack at a temperature of at least about 300° C., at least about 400° C., or at least about 500° C. In some embodiments, first layer 272 and/or second layer 276 of variable focus lens 260 comprising glass, ceramic, and/or glass-ceramic materials can enable the first layer and/or the second layer to withstand high temperature deposition processes. In some embodiments, first layer 272 and/or second layer 276 comprises an absorbing material (e.g., blue filter glass) as described herein. For example, the absorbing material is an inorganic material such that first layer 272 and/or second layer 276 comprising the absorbing material is able to withstand the high temperature deposition processes.

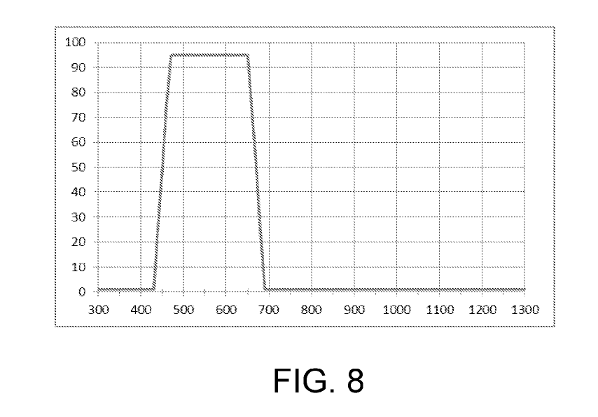

In some embodiments, optical filter 230 is a bandpass filter. FIG. 8 is a graph of an exemplary transmission profile of optical filter 230. The transmission profile is the transmission of optical filter 230 as a function of wavelength. The wavelength values on the x-axis are given in nanometers (nm). The transmission values on the y-axis are given in percent (%). A cutoff wavelength of optical filter 230 is a wavelength at which the optical filter exhibits a transmission of 50%. In some embodiments, optical filter 230 transmits light (e.g., visible light) in a transmission wavelength range and blocks light (e.g., UV light) in a lower wavelength range below the transmission wavelength range (e.g., below a lower cutoff wavelength) and light (e.g., near-IR light) in an upper wavelength range above the transmission wavelength range (e.g., above an upper cutoff wavelength). In some embodiments, in an operating wavelength range of 300 nm to 1300 nm, optical filter 230 comprises a lower cutoff wavelength of at most about 450 nm, at most about 440 nm, at most about 430 nm, at most about 420 nm, at most about 410 nm, or at most about 400 nm. Additionally, or alternatively, in the operating wavelength range of 300 nm to 1300 nm, optical filter 230 comprises an upper cutoff wavelength of at least about 600 nm, at least about 610 nm, at least about 620 nm, at least about 630 nm, at least about 640 nm, at least about 650 nm, at least about 660 nm, or at least about 670 nm. The lower cutoff wavelength is less than the upper cutoff wavelength. For example, in the embodiments shown in FIG. 8, optical filter 230 comprises a lower cutoff wavelength of 450 nm and an upper cutoff wavelength of 670 nm. Additionally, or alternatively, optical filter 230 comprises a transmission of at least 80% in a transmission wavelength range of about 450 nm to about 580 nm. For example, in the embodiments shown in FIG. 8, optical filter 230 comprises a transmission of at least 80% over a transmission wavelength range of 465 nm to 655 nm. Thus, at all wavelengths from 465 nm to 665 nm, optical filter 230 exhibits a transmission of at least 80%.

In some embodiments, optical filter 230 comprises a dielectric stack (e.g., of first optical filter segment 230A) that blocks (e.g., reflects) light in the lower wavelength range below the lower cutoff wavelength. Additionally, or alternatively, optical filter 230 comprises an absorbing layer (e.g., of second optical filter segment 230B) that blocks (e.g., absorbs) light in the upper wavelength range above the upper cutoff wavelength.

In various embodiments, image sensor 220 comprises a semiconductor charge-coupled device (CCD), a complementary metal-oxide-semiconductor (CMOS), an N-type metal-oxide-semiconductor (NMOS), another image sensing device, or a combination thereof. Image sensor 220 detects image light 10 focused on the image sensor by optical system 210 to capture the image represented by the image light.

In some embodiments, a method of forming a variable focus lens comprises bonding a plurality of layers to form a cavity defined between a first window and a second window. For example, a method of forming variable focus lens 260 comprises bonding first outer layer 272 to an object side surface of intermediate layer 274. Additionally, or alternatively, the method comprises bonding second outer layer 276 to an image side surface of intermediate layer 274. In some embodiments, intermediate layer 274 comprises a bore formed therethrough as described herein. For example, the method comprises forming the bore in intermediate layer 274 prior to the bonding. In some embodiments, the method comprises depositing first liquid 264 and second liquid 266 into the bore formed in intermediate layer 274. For example, the method comprises bonding one of first outer layer 272 or second outer layer 276 to intermediate layer 274, depositing first liquid 264 and second liquid 266 into the bore formed in the intermediate layer, and bonding the other of the first outer layer or the second outer layer to the intermediate layer to form the cavity between first window 268 and second window 270 with the first liquid and the second liquid disposed therein. Thus, first liquid 264 and second liquid 266 can be sealed in the cavity following the bonding.

In some embodiments, the method comprises forming an array of variable focus lenses. For example, intermediate layer 274 comprises a sheet (e.g., a substantially planar sheet) comprising an array of bores formed therein. In some of such embodiments, each of first outer layer 272 and second outer layer 276 comprises a sheet (e.g., a substantially planar sheet) such that the bonding the first layer and the second layer to intermediate layer 274 forms an array of cavities. In some embodiments, the method comprises depositing first liquid 264 and second liquid 266 into each bore such that the bonding forms an array of cavities between an array of first windows and a corresponding array of second windows with volumes of the first liquid and the second liquid disposed therein (e.g., an array of liquid lenses). In some embodiments, the method comprises singulating the array of variable focus lenses to form a plurality of separate variable focus lenses. For example, the singulating comprises severing first outer layer 272, intermediate layer 274, and second outer layer 276 in regions between adjacent cavities. Forming an array of variable focus lenses can enable high volume manufacturing of variable focus lenses. Additionally, or alternatively, forming an array of variable focus lenses can enable more efficient integration of the optical filter into the variable focus lens as described herein.

In some embodiments, the method comprises forming at least a portion of an optical filter on a layer of the variable focus lens. For example, the method comprises forming first optical filter segment 230A on first outer layer 272. In some embodiments, the forming first optical filter segment 230A comprises depositing alternating layers of the high refractive index material and the low refractive index material on the surface of first outer layer 272 (e.g., using a deposition process as described herein). Additionally, or alternatively, the method comprises forming second optical filter segment 230B on second outer layer 276. In some embodiments, the forming second optical filter segment 230B comprises depositing an absorbing layer and/or an AR layer on the surface of second outer layer 276 (e.g., using a deposition process as described herein). In some embodiments, the forming first optical filter segment 230A and/or the forming second optical filter segment 230B is performed prior to the bonding first outer layer 272 and/or second outer layer 276 to intermediate layer 274. Thus, the forming first optical filter segment 230A and/or the forming second optical filter segment 230B can be performed using a deposition process that may be unsuitable for intermediate layer 274, first liquid 264, and/or second liquid 266 (e.g., a high temperature deposition process). Additionally, or alternatively, the forming first optical filter segment 230A and/or the forming second optical filter segment 230B is performed as part of forming an array of variable focus lenses. Thus, first outer layer 272 and/or second outer layer 276 can be relatively large sheets, which can enable the forming optical filter 230 thereon to be done more efficiently. Such an efficient process can be enabled by the planar outer surfaces of variable focus lens 260, and may not be feasible for integrating an optical filter with a fixed lens having non-planar outer surfaces, which may not be formed as an array.

By including a variable focus lens (e.g., a liquid lens) in the lens stack instead of a voice coil motor to perform the function of autofocus and/or optical image stabilization, the image capture device can be free of moving parts. Additionally, or alternatively, the variable focus lens comprises flat glass opposing surfaces, which can accommodate the bandpass cutoff dielectric coating of the optical filter. The absence of moving parts in the lens stack can enable the lens stack to be permanently affixed to the image sensor, which can enable the lens stack to serve as a dust cover. This eliminates a separate component (e.g., a separate optical filter plate) in the image capture device and enables the optical train to become thinner, which is an especially critical feature for mobile phone cameras.

Placing the cutoff filter on the variable focus lens enables a thinner camera lens design. Additionally, or alternatively, since the position of the variable focus lens in the lens design is often closer to the pupil, the variable focus lens has a smaller diameter than the image or image sensor. Therefore, the diameter of the optical filter can be smaller, and the cost of the dielectric coating can be reduced relative to a device comprising a separate optical filter plate near the image sensor. For example, the diameter of the optical filter integrated with the optical system can be 4 times smaller than the diameter of a separate optical filter plate of a conventional imaging device having an image sensor of the same size and an optical system of the same optical power.

To achieve autofocus in a conventional image capture device (e.g., as shown in FIG. 1), the whole lens stack moves axially (e.g., along the optical axis) to refocus the optical system for different object distances. This motion is typically achieved using a voice coil motor assembly. This motion can generate and/or move small particles. Thus, the optical filter can be placed over the image sensor surface to serve as a dust cover and prevent particles from falling on the image sensor. Since pixels of the image sensor generally are small (e.g., approaching 1 micron), even a small dust particle can block an entire pixel, limiting functionality and affecting picture quality.

If autofocus and optical image stabilization functionality are implemented with an image capture device comprising a variable focus lens as described herein (e.g., as shown in FIG. 2), there is no need to move the optical system relative to the image sensor. Instead, in some embodiments, a voltage can be applied equally across four electrodes of a liquid lens to create surface tension between the polar fluid and oil of the liquid lens and cause a curvature difference between the fluids and positive optical power. Additionally, or alternatively, by applying unequal voltage across two of the four electrodes, the liquid lens surface can be tilted to compensate for hand motion and achieve optical image stabilization.

Since the optical system does not need to move relative to the image sensor with the implementation of the variable focus lens, the lens stack can be permanently attached to the image sensor and serve as a dust cover. Additionally, or alternatively, the liquid lens has two flat glass surfaces, either of which can be an ideal location for applying the dielectric bandpass spectral filter (e.g., the optical filter).

In some embodiments, an electronic device comprises a variable focus lens and/or an image capture device as described herein. For example, the electronic device comprises a camera module comprising the image capture device. In some embodiments, the electronic device comprises a smartphone, a tablet computer, or a digital camera. Additionally, or alternatively, the electronic device comprises an optical focus, an autofocus, and/or an optical image stabilization function controlled by changing the shape of the interface of the variable focus lens as described herein.

It will be apparent to those skilled in the art that various modifications and variations can be made without departing from the spirit or scope of the claimed subject matter. Accordingly, the claimed subject matter is not to be restricted except in light of the attached claims and their equivalents.

1. A liquid lens comprising:
a lens body comprising a first window, a second window, and a cavity disposed between the first window and the second window;
a first liquid and a second liquid disposed within the cavity of the lens body, the first liquid and the second liquid substantially immiscible with each other and having different refractive indices such that an interface between the first liquid and the second liquid forms a lens; and
an optical filter integrated with at least one of the first window or the second window;
wherein the optical filter is a bandpass filter, and in an operating wavelength range of 300 nm to 1300 nm, the optical filter comprises a lower cutoff wavelength of at most about 450 nm and an upper cutoff wavelength of at least about 600 nm.

2-3. (canceled)

4. The liquid lens of claim 1, wherein the optical filter comprises a transmission of at least 80% in a transmission wavelength range of about 450 nm to about 580 nm.

5. The liquid lens of claim 1, wherein the optical filter comprises a dielectric stack disposed on an outer surface of at least one of the first window or the second window and comprising alternating layers of a high refractive index material and a low refractive index material.

6. The liquid lens of claim 5, wherein the dielectric stack blocks light in a lower wavelength range below the lower cutoff wavelength.

7. The liquid lens of claim 5, wherein the dielectric stack comprises an anti-reflection filter.

8. The liquid lens of claim 5, wherein:
the optical filter comprises a first dielectric stack disposed on the outer surface of the first window and a second dielectric stack disposed on the outer surface of the second window;
the first dielectric stack blocks light in a lower wavelength range below the lower cutoff wavelength; and
the second dielectric stack is an anti-reflection filter.

9. The liquid lens of claim 5, wherein the optical filter comprises an absorbing layer that absorbs light in an absorption wavelength range above the upper cutoff wavelength.

10. The liquid lens of claim 9, wherein the absorbing layer is disposed on the outer surface of at least one of the first window or the second window.

11. The liquid lens of claim 9, wherein at least one of the first window or the second window is formed from an absorbing material such that the at least one of the first window or the second window comprises the absorbing layer.

12. The liquid lens of claim 1, wherein
the outer surface of the at least one of the first window or the second window is substantially planar.

13. The liquid lens of claim 1, wherein the outer surface of the at least one of the first window or the second window is non-planar.

14. An image capture device comprising:
an optical system comprising a variable focus lens;
an image sensor; and
an optical filter integrated with the optical system;
wherein each of the image sensor and the optical filter is aligned along an optical axis of the optical system; and
wherein each of the variable focus lens and the image sensor is bonded to a housing such that a sealed chamber is defined within the housing between the variable focus lens and the image sensor.

15-18. (canceled)

19. The image capture device of claim 14, wherein the variable focus lens is a liquid lens comprising an interface between a first liquid and a second liquid.

20. The image capture device of claim 14, wherein the optical filter comprises a bandpass filter.

21. (canceled)

22. An electronic device comprising the liquid lens of claim 1.

23. (canceled)

24. A method for forming a liquid lens, the method comprising:
forming at least a portion of an optical filter on a surface of one of a first outer layer or a second outer layer;
bonding the first outer layer to an object side surface of an intermediate layer and bonding the second outer layer to an image side surface of the intermediate layer, thereby forming a cavity disposed between the first outer layer and the second outer layer.

25. The method of claim 24, further comprising depositing a first liquid and a second liquid into a bore formed in the intermediate layer between the bonding the first outer layer to the object side surface of the intermediate layer and the bonding the second outer layer to the image side surface of the intermediate layer, thereby sealing the first liquid and the second liquid within the cavity.

26. The method of claim 24, wherein the forming at least a portion of the optical filter comprises depositing alternating layers of a high refractive index material and a low refractive index material on the surface of the one of the first outer layer or the second outer layer.

27. The method of claim 24, wherein the liquid lens is one of an array of liquid lenses, and the method further comprises singulating the array of liquid lenses.

28. The liquid lens of claim 8, wherein the optical filter comprises an absorbing layer disposed between the second window and the anti-reflection filter.
